(19) United States
(12) Patent Application Publication
(10) Pub. No.: US 2026/0293920 A1
(43) Pub. Date: Oct. 1, 2026

(54) FERMENTED MILK DRINK FOR MENTAL PERFORMANCE AND PRODUCTION METHOD

(71) Applicant: ALPINA PRODUCTOS ALIMENTICIOS S.A.S. - BIC, Sopo (CO)

(72) Inventors: Mary Luz CANO SEPÚLVEDA, Sopo (CO); Bernadette Francisca KLOTZ CEBERIO, Sopo (CO)

(21) Appl. No.: 19/141,160

(22) PCT Filed: Dec. 22, 2023
(86) PCT No.: PCT/IB2023/063203

§ 371 Date: Jun. 19, 2025

(30) Foreign Application Priority Data
Dec. 22, 2022 (CO) NC2022/0018758
Dec. 22, 2023 (CO) NC2023/0018200

(51) Int. Cl. A23C 9/13; A23C 9/123

(52) U.S. Cl. CPC A23C 9/1322; A23C 9/1234; A23C 9/1236; A23C 9/1307

(57) ABSTRACT

The present development is related to the formulation of a fermented dairy drink that contributes to mental performance, characterized by comprising vitamin B5, vitamin B12, and choline, as well as its method for obtaining it through acidification with a starter strain and a GABA-producing probiotic strain. Additionally, tests of the physicochemical and microbiological stability and functional characteristics of the developed formulation are included.

### TECHNICAL FIELD

This disclosure relates to food products for human needs. It particularly relates to dairy products processed with microorganisms or enzymes providing functional characteristics to the product, contributing to mental performance.

### DESCRIPTION OF THE PRIOR ART

Today's world has changed its dynamics and perceptions of healthy lifestyles. The approach defined during the pandemic years has generated increasingly popular product concepts defined as natural, healthy, and nutritious. In addition to these new products, new lifestyles have emerged, such as remote work and the need to counteract numerous ailments with products that fulfill this premise while also providing a defined functionality.

The recent increase in the creation and participation of functional drinks worldwide, wherein mental performance is one of the five most relevant concerns regarding physical, mental, and emotional well-being, created a clear opportunity to introduce a new product into the Colombian market. A product seeking to provide consumers with an affordable dairy-based food product in the mass consumption segment, designed to enhance mental performance, manufactured with healthy raw materials that contribute a nutritional profile and meet all of the user's sensory expectations.

For instance, patent CN106259935 discloses a fermented milk and fruit juice drink with probiotic activity, wherein the preparation process includes separate fermentation of milk and fruit pulp, each employing strains of Lactobacillus and Streptococcus. Additionally, patent U.S. Pat. No. 1,132,419 describes a liquid, acidified, high-protein dairy product, and its production method, wherein the acidifying agent may include Lactobacillus, Leuconostoc, Lactococcus, and Streptococcus. Moreover, this document describes that the dairy product may contain combinations of certain vitamins and nutrients.

Lactic acid bacteria have been widely used for the production of fermented drinks and food preservation. However, it is also known that not all strains of lactic acid bacteria are capable of producing GABA, an inhibitory neurotransmitter that, when consumed through foods, acts as a bioactive compound beneficial to health. As previously mentioned, functional foods must not only be sensorially appealing and nutritious but also contribute to the prevention or mitigation of the development of certain diseases. Consequently, consumers demand the development of new products that provide additional health benefits beyond basic nutrition, such as fermented dairy drinks that support mental performance.

In response to this opportunity, the present development seeks to: (i) establish the processing and formulation conditions required to obtain a functional prototype enhancing a shot-type fermented dairy drink at pilot scale; (ii) evaluate the physicochemical, microbiological, and sensory attributes of the functional fermented dairy drink prototype to establish processing conditions at a semi-industrial scale; and (iii) evaluate the functionality of the dairy drink prototype for mental performance through a clinical study.

### BRIEF DESCRIPTION OF THE FIGURES

FIG. 1. Process diagram for obtaining a semi-industrial prototype of a fermented dairy drink.

FIG. 2. Fermentation curve of semi-industrial tests: Test 1 (addition of vitamin mixture at mixing step) and Test 2 (addition of vitamin mixture during the acidification step); both inoculated at 40° C.

FIG. 3. Fermentation curve of the industrial-scale test with the starter strain Streptococcus thermophilus, inoculation at 38-45° C.; concentration of 1 UC/100 L (1×10¹⁰ to 1×10¹² CFU/g); dosage from 0.0005-0.005% w/w; fermentation time from 5-8 hours; and pH cut-off 4.70-4.50.

FIG. 4A-4B. Viability graphs of starter and probiotic strain concentrations over shelf life (37 days) (on the x-axis: 1=0 days, 2=11 days, 3=20 days, 4=29 days, and 5=37 days); under refrigeration (4° C.) and freezing (−20° C.) conditions. A. 4° C. storage L. Brevis; B. −20° ° C. storage L. Brevis; C. 4° C. storage S. salivarius; D. −20° C. storage S. salivarius. Samples: 45.1 2 mg/100 mL of product (BS45.1); 45.2 4 mg/100 mL of product (BS45.2); 45.3 20 mg/100 mL of product (BS45.3).

FIG. 5A-5B. Sensory results of the semi-industrial prototype obtained in the attribute description test for apple-green tea and berry mixture.

FIG. 6A-6B. Sensory results of the semi-industrial prototype obtained in the acceptance test (acceptance, indifference, or rejection) for apple-green tea and berry mixture.

FIG. 7. Comparison of GABA production by various strains of lactobacilli. The measurements correspond to the first hours of bacterial growth.

FIG. 8A-8B. A) GABA production by L. brevis DHel_24_DWN at different times and glutamate concentrations. B) GABA production by L. brevis DHel_24_DWN under intestinal conditions at 72 and 144 h. C) Survival of L. brevis DHel_24_DWN under gastric and intestinal conditions compared to other lactobacilli strains. D) Survival of L. brevis DHel_24_DWN under prolonged intestinal conditions (72 and 144 h).

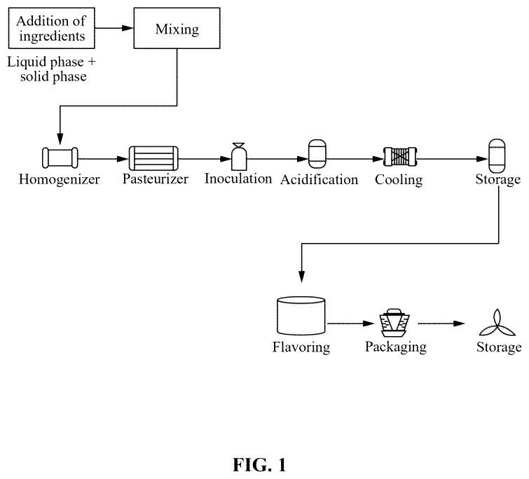

### DETAILED DESCRIPTION

Unless otherwise indicated, all percentages stated herein are expressed by weight (w/w). The term “about” refers to a deviation of at least ±5% from the specified value.

### Formulation of a Fermented Dairy Drink

In one aspect, the present disclosure relates to fermented dairy compositions designed to include functional components that contribute to mental performance. The components included in the developed dairy drink formulation comprise, but are not limited to, a dairy matrix, a starter strain, a GABA-producing probiotic strain, and a nutrient mixture.

For the purposes of the present disclosure, the “dairy matrix” is characterized as a composition comprising: lipids, proteins, carbohydrates, minerals, and other minor components. The dairy matrix may include one or more of the following components: milk and a concentrated mixture of added whey. “Milk” refers to skim milk, low-fat milk, whole milk, lactose-free milk, concentrated milk, or milk powder. “Whey” or “whey from milk” refers to the component of milk remaining after the total or substantial removal of fat and casein during various physical processes.

In one embodiment, the formulation includes one or more starter strains, which are lactic acid bacteria. Starter strains are selected from, but not limited to, Streptococcus spp., Lactobacillus spp., Lactococcus spp., Lacticaseibacillus spp., Lactiplantibacillus spp. In a preferred embodiment, the strain is Streptococcus spp., more preferably Streptococcus thermophilus, at a concentration from 1×10¹⁰ CFU/g to 1×10¹² CFU/g, preferably at a concentration of about 1×10¹¹ CFU/g. In one embodiment, the formulation comprises the starter strain Streptococcus salivarius subsp. thermophilus, at a concentration from 1×10¹⁰ CFU/g to 1×10¹² CFU/g, preferably at a concentration of about 1×10¹¹ CFU/g.

In one embodiment, it is possible to define that the quantity of starter strain present in the formulation is defined by its unit of activity per liter. For the purposes of this development, a “unit of activity” (symbol U) is defined as the catalytic activity responsible for the transformation of a μmol of substratum by minute under optimal strain conditions. This is also used in combination with other units (U/mg or U/mL) to indicate, respectively, the specific activity or the activity concentration of the strain. In one embodiment, the starter strain is in a range from 0.5 to 1.5 U/100 L, 0.8 to 1.2 U/100 L, of about 1 U/100 L, preferably 1 U/100 L.

In a preferred embodiment, the starter strain is Steptococcus thermophilus and is present at about 1 U/100 L, preferably 1 U/100 L. In particular, for conversion purposes, to have 1 U/100 L of the starter strain Steptococcus thermophilus, between 1×10¹⁰ and 1×10¹² CFU/g are needed.

The formulation also includes a GABA-producing probiotic strain. The GABA-producing probiotic strain corresponds to lactic acid bacteria which may be, but are not limited to, the genera Lactobacillus spp., Lactococcus spp., and Streptococcus spp., Lacticaseibacillus spp., Lactiplantibacillus spp., and Levilactobacillus spp. In one embodiment, the strain may be Lactobacillus brevis (Levilactobacillus brevis), Lactobacillus plantarum (Lactiplantibacillus plantarum) or Lactobacillus paracasei (Lacticaseibacillus paracasei). In a preferred embodiment, the GABA-producing probiotic strain is Lactobacillus brevis. In one embodiment, the formulation comprises the GABA-producing probiotic strain Lactobacillus brevis at a concentration from 1×10¹⁰ CFU/g to 1×10¹² CFU/g, preferably at a concentration of 1×10¹¹ CFU/g. Additionally, in a preferred embodiment the developed formulation has a probiotic count from 1.0×10⁶ to 1.0×10⁷ CFU/mL.

Additionally, the developed dairy drink formulation includes a nutrient mixture developed to support mental performance, which contains choline, vitamin B5, and vitamin B12. In a preferred embodiment, the nutrient mixture comprises choline from 5 to 20%, preferably from 10 to 15%, vitamin B5 from 0.1 to 0.9%, preferably from 0.2 to 0.5%, and vitamin B12 from 0 to 0.5%, preferably from 0 to 0.1%.

The fermented dairy drink formulation can have different types of forms. For example, the formulation should preferably be sweetened. In some embodiments, the formulation may be sweetened with fruit preparations, flavor modulators, or sweeteners, among others. In one embodiment, the dairy drink formulation comprises a nutritive sweetener such as sugar, syrup, glucose, dextrose, fructose, galactose, sucrose, and mixtures thereof. In one embodiment, the food mixture is sweetened with a non-nutritive sweetener such as saccharin, aspartame, sucralose, among others known to the person of ordinary skill in the art. In a preferred embodiment, the sweetener is sucrose. The concentration of the sweetener in the formulation is from 5 to 10%, 6 to 8%, 7 to 9%, of about 6 to 10%, of about 7 to 9%, of about 8%, preferably at a concentration from 8 to 9%. In one embodiment, the total sugars in the finished product are at a concentration from 10 to 12%.

On the other hand, the formulation may be flavored. In some embodiments the formulation is flavored with natural flavorings or artificial flavorings. In one embodiment, the formulation may have a flavor of fruits, grains, or plant extracts, among others. In a preferred embodiment, the formulation is flavored with apple-green tea or mixed berries.

In one embodiment, the formulation comprises 1.5 to 5% protein, 1 to 3% fat, and 15 to 20% total solids.

In one embodiment, the fermented dairy drink formulation comprises 60 to 99% dairy matrix, 0.0001 to 5% or 0.005 to 5% starter strain, 0.002 to 5% GABA-producing probiotic strain, and 0.5 to 5% nutrient mixture.

In a preferred embodiment, the fermented dairy drink formulation comprises 70 to 99% dairy matrix, 0.0005 to 0.005% starter strain, 0.002 to 0.01% GABA-producing probiotic strain, and 0.5 to 0.9% nutrient mixture.

### Process for Obtaining a Fermented Dairy Drink

In a second aspect, the present disclosure relates to a process for obtaining the fermented milk drink that contributes to mental performance, as described above.

The process for obtaining the fermented milk drink of the present disclosure begins with the inoculation of a pasteurized food mixture with a starter culture and a probiotic strain. As used herein, the term “food mixture” refers to the mixture that is characterized in that it comprises milk, whey, sweeteners, stabilizers, and, optionally, preservatives.

For the purposes of the present disclosure, the selection and concentration of the sweetener in the food mixture plays a significant role in various aspects of the process, as the sweetener not only affects the sensory profile of the final product but also influences the viability and metabolic activity of the starter and probiotic strains during fermentation. Furthermore, the interaction between the sweetener and the strains may impact the production of specific metabolites. Accordingly, the selection of sweetener has implications for the texture and flavor of the product, as well as its nutritional properties and therapeutic value. Additionally, the concentration of the sweetener in the food mixture is related to consumer acceptance of the fermented milk drink.

In one embodiment, the food mixture is sweetened with a nutritive sweetener selected from the group comprising glucose, dextrose, fructose, galactose, sucrose, and mixtures thereof. In one embodiment, the food mixture is sweetened with a non-nutritive sweetener such as saccharin, aspartame, sucralose, among others. In a preferred embodiment, the sweetener is sucrose. The concentration of the sweetener in the food mixture ranges from 5 to 10%, 6 to 8%, 7 to 9%, of about 6 to 10%, of about 7 to 9%, of about 8%, preferably at a concentration from 8 to 9%.

The food mixture may comprise a stabilization system comprising one or more of the following: alginates, carrageenans, caseins, gums, carboxymethylcellulose, pectins, proteins, or mixtures thereof, or others known to the person of ordinary skill in the art.

For the purposes of the present disclosure, the food mixture is inoculated simultaneously with a starter strain and a GABA-producing probiotic strain, as it has been found that the fermentative behavior of the starter and probiotic strains is compatible and affects the time required to reach the pH cut-off.

The inoculated mixture is acidified for more than 4 hours, at a temperature from 35 to 50° C. and reaching a pH between 4 to 5. In one embodiment, the inoculated mixture is acidified for 5 to 10 hours at a temperature from 38 to 45° C. and reaching a pH between 4.5 to 4.7.

The inoculation of the fermented mixture may include one or more starter strains, which are lactic acid bacteria that may be, but are not limited to, Streptococcus spp., Lactobacillus spp., Lactococcus spp., Lacticaseibacillus spp., and Lactiplantibacillus spp. In a preferred embodiment, the strain is Streptococcus spp. In a preferred embodiment, the process comprises inoculating the feed mixture with the strain Streptococcus spp., more preferably Streptococcus thermophilus, at a concentration from 1×10¹⁰ CFU/g to 1×10¹² CFU/g, preferably at a concentration of about 1×10¹¹ CFU/g. In one embodiment, the inoculation of the feed mixture is carried out with the starter strain Streptococcus salivarius subsp. thermophilus at a concentration from 1×10¹⁰ CFU/g to 1×10¹² CFU/g, preferably at a concentration of about 1×10¹¹ CFU/g.

In one embodiment, it is possible to define that the quantity of strain to be added to the feed mixture is defined by its unit of activity per liter. In one embodiment, the starter strain is in a range from 0.5 to 1.5 U/100 L, 0.8 to 1.2 U/100 L, of about 1 U/100 L, preferably 1 U/100 L.

The process also includes a GABA-producing probiotic strain, which are lactic acid bacteria that can be, but are not limited to, the genera Lactobacillus, Lactococcus and Streptococcus. In one embodiment, the strain may be Lactobacillus brevis (Levilactobacillus brevis), Lactobacillus plantarum (Lactiplantibacillus plantarum) or Lactobacillus paracasei (Lacticaseibacillus paracasei). In a preferred embodiment, the GABA-producing probiotic strain is Lactobacillus brevis. In one embodiment, the process comprises inoculating the feed mixture with the GABA-producing probiotic strain Lactobacillus brevis at a concentration from 1×10¹⁰ CFU/g to 1×10¹² CFU/g, preferably at a concentration of 1×10¹¹ CFU/g.

After obtaining the acidified mixture with the determined pH, the mixture is cooled, which in one embodiment carried out at a cooling temperature from 5 to 15° C., preferably from 6 to 8° C., and until a cooled mixture with a viscosity from 45 to 450 cP, preferably from 50 to 350 cP, is obtained.

Once the cooling process is complete, a nutrient mixture comprising choline, vitamin B5, and vitamin B12 is added to the cooled mixture. If the mixture is not cooled, the acidification process continues, which changes the sensory and survival conditions of the probiotic microorganisms.

In one embodiment, the nutrient mixture is in the form of a powder mixture comprising choline from 5 to 20%, preferably from 10 to 15%, vitamin B5 from 0.1 to 0.9%, preferably from 0.2 to 0.5%, and vitamin B12 from 0 to 0.5%, preferably from 0 to 0.1%.

The addition of the nutrient mixture to the cooled acidified mixture is carried out at a temperature from 10 to 20° C., preferably at a temperature from 15 to 20° C.

In a preferred embodiment, the nutrient mixture that is incorporated into the cooled mixture is obtained from a nutrient mixture powder, as follows:
i) dissolving the nutrient mixture in water at a temperature from 28 to 32° C.;
ii) homogenizing the mixture from step (i) until a total dilution is achieved;
iii) cooling the mixture from step (ii) to a temperature from 15 and 20° C. and obtaining the solution of a nutrient mixture.

It is important to emphasize the need for proper handling to maintain microbiological specifications and prevent contamination.

The nutrient mixture is added to an amount from 20 and 30% in the water to obtain the solution of a nutrient mixture.

Optionally, a flavoring step may be included in the process for producing the fermented milk drink of the present disclosure, for example, using natural or artificial flavorings. In one embodiment, the flavoring step is carried out with fruit flavors, grain flavors, or plant extract flavors, among others.

### EXAMPLES

All pasteurized bases were stored in an incubation refrigerator at 41° C. Cooling was carried out at a pH cut-off between 4.5 and 4.7.

### Example 1. Consolidation of Process Condition for the Pilot Prototype

Various tests were conducted to determine the most favorable conditions for the pilot prototype, wherein the optimal sequence of steps for obtaining the developed formulation was identified. First, it was found that the addition of the nutrient mixture cannot be carried out during the mixing, inoculation, or acidification steps, as the pH of the mixture drops below 6, which is a risk to the production process due to an imbalance in the production of secondary metabolites necessary for the proper formation of the fermented curd, leading to critical sensory issues such as chalky texture and significant lump formation.

Second, the fermentative behavior of the starter strain (Streptococcus salivarius subsp. thermophilus) and the probiotic strain (Lactobacillus brevis) were evaluated from the beginning of the fermentation process and the change generated by adding the probiotic strain at the end, that is, in the cooling step. This evaluation made it possible to determine the effect of pH depending on whether the probiotic culture was added during the inoculation step (simultaneously with the starter culture) or during the cooling step. The response in the probiotic microorganism count was evaluated and no differential concentrations were evident, so it is concluded that the best time to carry out this addition is at the beginning of the fermentation process together with the starter strain.

In addition, it was established that the optimal fermentation time for the dairy matrix ranges from 6.5 to 7.5 hours (variation that depends on the inoculation temperature 39-41° C.).

It was determined that a pre-dilution of the nutrient mixture in water is necessary, as the preparation of a solution facilitates the homogenization of the nutrient mixture within the matrix and helps reduce sensory defects (e.g., choline crystallization in the dairy matrix).

Table 1 summarizes the process conditions required to successfully carry out the pilot prototype.

TABLE 1
Consolidation of Final Process Conditions - Pilot Prototype

| Step | Variable | Result | |
|---|---|---|---|
| Ingredient | pH | 6.48-6.58 | |
| Mixture | Brix degrees (°Bx) | 15.5-16.5% | |
| | Order of ingredient addition | Adding ingredients: | |
| | | milk, whey, sugar. | |
| | | Adding other | |
| | | ingredients: stabilization | |
| | | system, preservatives. | |
| | | Inoculation: starter strain | |
| | | and probiotic strain. | |
| | | At the end of the cooling | |
| | | process: nutrient | |
| | | mixture. | |
| Homogenization | Pressure | 100-120 | bar |
| | Temperature | 50-55° | C. |
| Pasteurization | Pasteurization temperature/ | 90° C./3 s | |
| | Holding time | | |
| | Cooling temperature | 40° | C. |
| | pH | 6.38-6.42 | |
| Acidification | Acidification time | 6.5-7.5 | h |
| | Acidification temperature | 39.5-41.5° | C. |
| | pH cut-off | 4.70-4.60 | |
| Cooling | Cooling temperature | 19-22° | C. |
| | pH | 4.12-4.30 | |
| | Viscosity | 200 | cps |
| Flavoring | Stirring time | 10 | min |

| | | |
|---|---|---|
| Packing | Fat (% m/m) | 1.45-1.60% |
| | Protein (% m/m) | 2.45-2.75% |
| | Total Solids (% m/m) | 16.0-17.5% |

### Example 2. Adaptation of Process Conditions on a Semi-Industrial Scale

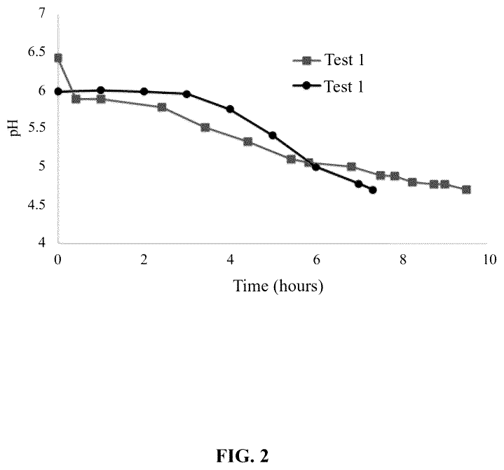

For the scaling of the pilot prototype of Example 1 to a semi-industrial scale, two semi-industrial tests were carried out to check the best time for the addition of the vitamin (nutrient) mixture. FIG. 2 shows the fermentation curves obtained. In Test 1, the ingredient mixture was added during the acidification step. However, it is evident that the observed pH drop interrupts the fermentation process and results in a prolonged acidification curve. It is worth noting that, in Test 2, the nutrient mixture was added in the mixing area to validate the concentration loss due to thermal processes, since the quantity required is more complex to add in the acidification area. However, a significant sensory defect was observed, along with a marked decrease in the pH of the pasteurized mixture.

Test 1 provided insight into the loss of nutrient concentration during the pasteurization process under semi-industrial conditions. A loss of 11% relative to the initial concentration was observed for choline and vitamin B5, and 70% for vitamin B12. Therefore, it becomes necessary to add the nutrient mixture during the flavoring step, a step in which proper handling of the vitamins can be achieved, including their predilution, a physicochemical process identified in the final phase of the pilot tests, and a better sensory profile due to the absence of molecular interferents during the fermentation step.

In order to scale the remaining conditions of the pilot prototype to industrial-scale processing conditions, an evaluation of the equipment and capacities available at the industrial level was carried out. To that end, the initial review considers the following:
Retention time of the pasteurizer: 10 minutes. Therefore, it was necessary to adjust the pasteurization conditions used at the pilot scale to those suitable for industrial scale, considering the protein denaturation curve and the time-temperature relationship. A pasteurization temperature from 80 to 84° C. for 10 minutes is proposed.
Cooling pumps: Based on the capacity of the pumps and the cooler, the cooling process is proposed at 15,000 L/h and an outlet temperature of 6-8° C.
Piping and equipment distances: It is necessary to adjust process cut points in order to mitigate product dilution.

The consolidated information on operational parameters is shown in Table 2.

TABLE 2
Consolidation of Final Process Conditions -
Semi-industrial Prototype.

| Step | Variable | Result |
|---|---|---|
| Ingredient | pH (pH units) | 6.70-6.68 |
| Mixture | Brix degrees (°Bx) | 15.9% |
| | Fat (% m/m) | 1.45% |
| | Order of ingredient addition | Adding ingredients: |
| | | milk, whey, sugar. |
| | | Adding other |
| | | ingredients: |
| | | stabilization system, |
| | | preservatives. |
| | | Inoculation: starter |
| | | strain and probiotic |
| | | strain. |
| | | Flavoring: nutrient |
| | | mixture, fruit |
| | | preparation, and |
| | | flavoring mixture. |
| | Dissolved oxygen (mg/L) | 6.02 |
| Homogenization | Pressure (bar) | 100-120 |
| | Temperature (° C.) | 55-65 |
| Pasteurization | Pasteurization temperature | 80-84° C./10 minutes. |
| | (° C.) | 40-42° C. due to |
| | Cooling temperature (° C.) | temperature loss. |
| | pH (pH units) | 6.42-6.45 |
| | Fat (% m/m) | 1.45 |
| | Brix degrees (°Bx) | 16.4 |
| | Dissolved oxygen (mg/L) | 5.35 |
| Acidification | Acidification time (hours) | 8-11 approx. hours |
| | Acidification temperature | 40 |
| | (° C.) | |
| | pH cut-off (pH units) | 4.70-4.65 |
| Cooling | Cooling temperature (° C.) | 6-8 |
| | pH (pH units) | 4.65 |
| | Viscosity (cP) | 200-350 |
| | Sensory evaluation | Satisfactory |
| Storage | Storage temperature (° C.) | 6-8 |
| | pH (pH units) | 4.65 |
| | Dissolved oxygen (mg/L) | 2.70 |
| Flavoring | Stirring Time (min) | 10 |
| | Addition of nutrient mixture | In 20-30% dilution |
| Packing | Sensory evaluation | Satisfactory |
| | Dissolved oxygen (mg/L) | 2.40 |

### Example 3. Variation of the Starter Strain and Adaptation of Process Conditions on an Industrial Scale

For scaling up the process to an industrial scale, a variation of the starter strain was considered, as it was identified that fermentation times in the semi-industrial prototype could be reduced to obtain a more efficient process. The strain selected as a new starter strain for inoculation of the food mixture was Streptococcus thermophilus at a concentration of about 1×10¹¹ CFU/g. Table 3 shows the favorable conditions for inoculation of this strain.

TABLE 3
Inoculation conditions on an industrial scale

| Inoculation temperature | 38.0-45.0° | C. |
|---|---|---|
| Concentration | 1 U (activity unit)/100 L | |
| Dose | 0.00127% | w/w |
| Fermentation time | 5.0-8.0 | h |

| | |
|---|---|
| pH cut-off | 4.70-4.50 |

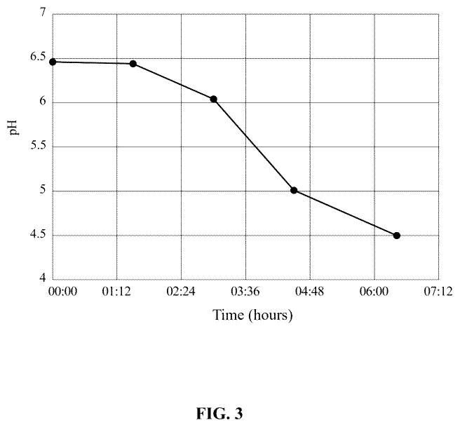

FIG. 3 shows the resulting fermentation curve, which demonstrates that the fermentation time can be reduced without compromising the sensory and functional characteristics of the final product. In comparison with the acidification step carried out in the tests of Examples 1 and 2, a pH cut-off is achieved within a fermentation time ranging from 5 to 8 hours, which represents a reduction in fermentation time of about 27 to 38% compared to the semi-industrial process.

### Example 4. Formulation of a Fermented Dairy Drink for Mental Performance

A formulation of a fermented dairy drink for mental performance was obtained from a defined process with the parameters defined in Example 3, comprising:
i) inoculating a food mixture comprising milk, whey, sweeteners, stabilizers, and preservatives, said mixture being pasteurized, with a starter strain and a probiotic strain, wherein the starter strain is Streptococcus thermophilus, and the GABA-producing probiotic strain is Lactobacillus brevis;
ii) acidifying the inoculated mixture to a pH below 4.7;
iii) cooling the resulting acidified mixture; and
iv) adding a nutrient mixture comprising choline, vitamin B5, and vitamin B12 to obtain a fermented dairy drink.

The formulation of the fermented dairy drink that exhibited the best organoleptic characteristics and stability is shown in Table 4.

TABLE 4
Formulation of Fermented Dairy Drink.

| Component | | Concentration |
|---|---|---|
| Milk Matrix | Milk | 70-99% |
| | Serum | |
| | Sweeteners | |
| Starter Strain | Streptococcus | 0.0005 to 0.005% |
| | thermophilus | |
| GABA-Producing | Lactobacillus | 0.002 to 0.01% |
| Probiotic Strain | brevis | |
| Nutrient Mixture | Choline | 0.5 to 0.9% |
| | Vitamin B5 | |
| | Vitamin B12 | |

| | |
|---|---|
| Fruit Preparation | 0-5% |
| Stabilizers | 0-1% |
| Preservatives | 0-0.1% |

### Example 5. Physicochemical and Microbiological Evaluation of the Final Product

The results of the physicochemical evaluation of the final product are shown in Table 5. Protein quantification was performed using a LECO-FP528 (St. Joseph, MI), which measures total nitrogen in the samples according to the DUMAS method and a conversion factor of 6.38 was used to calculate total protein. Fat content was determined by the Gerber method. Soluble solids were determined using an ATAGO PAL-1 digital refractometer (Tokyo, Japan) by adding 1 g of sample to the device.

For choline quantification, the concentration of this analyte was determined by standard chromatography: modified AOAC 2012.20, the concentration of vitamin B5 by the modified AOAC 952.20 (level<5 mg/100 g) and the concentration of vitamin B12 by the modified AOAC 945.74 (<75 mg/100 g).

TABLE 5
Physicochemical Results of the Final Product

| Parameter | Result |
|---|---|
| pH | 4.61 |
| Acidity (°Th) | 45.68 |
| Vitamin B5 (mg/100 g) | 2.41 |
| Vitamin B12 (μg/100 g) | 1.35 |
| Choline (mg/100 g) | 117 |
| Fat (%) | 1.58 |
| Protein (%) | 2.32 |
| Total Solids (%) | 17.13 |
| Ashes (%) | 0.48 |
| Viscosity (Cp) | 245 |

The results of the microbiological evaluation of the final product were carried out by conventional microbiological methods to determine of quality variables and probiotic count (MRS medium and incubation conditions: microaerophilia “candle jar” method). These results are shown in Table 6.

TABLE 6
Microbiological Results of the Final Product

| Parameter | Result |
|---|---|
| Probiotic Count (CFU/mL) | >1.0 × 10⁷ |
| Molds and Yeasts (CFU/mL) | <10 |
| Fecal Coliforms (CFU/mL) | <10 |
| Total Coliforms (CFU/mL) | <10 |

### Stability Study of Starter and Probiotic Strains on a Semi-Industrial Scale

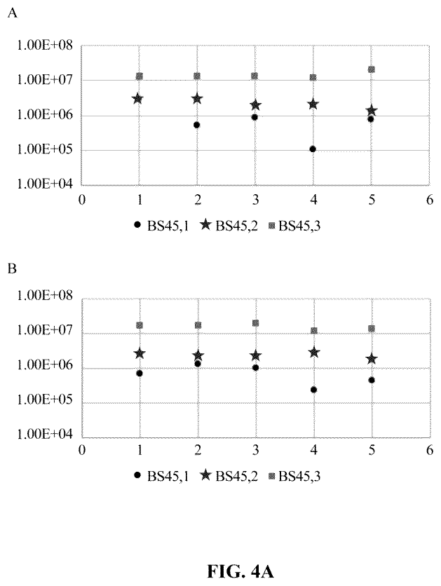

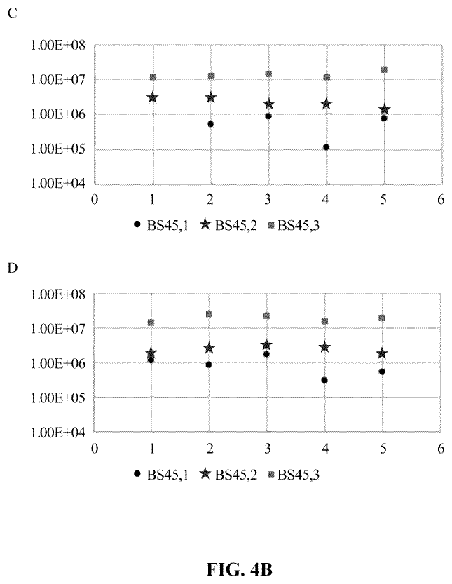

A study was conducted to determine the viability of the starter and GABA-producing probiotic strains over time under refrigeration and freezing conditions in order to assess the shelf life of the product. The results are shown in FIGS. 4A and 4B, which illustrate the behavior of the L. brevis and S. salivarius strains at 4° C. and −20° C. It was determined that, to maintain a concentration from 1×10⁶ to 1×10⁷ CFU/ml throughout the product's shelf life, the concentration of the probiotic strain must be 4 mg/100 ml and the concentration of the starter strain must be 5 mg/100 ml under freezing conditions.

### Example 6. Sensory Results of the Final Product

In order to determine the acceptance of the final product by users, some attribute description tests were carried out on two fermented dairy drink formulations with the composition shown in Table 4, with the difference that formulations were developed with two different flavors: apple green tea and mixed berries.

Sensory tests of attribute description and acceptance were carried out on a population of 20-25 trained volunteers, who received sensory evaluation samples (“shots”) throughout the product's shelf life.

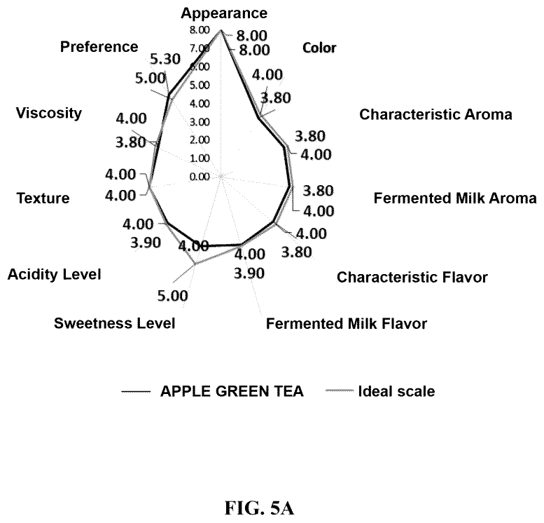

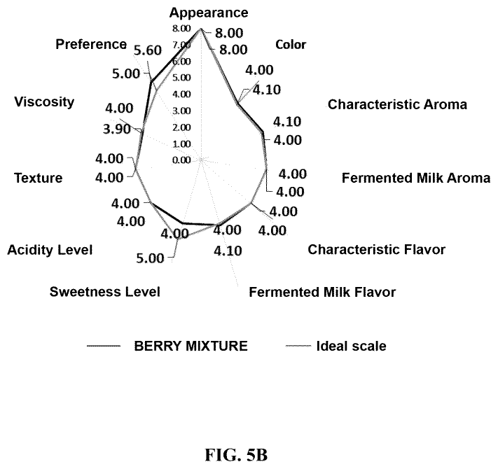

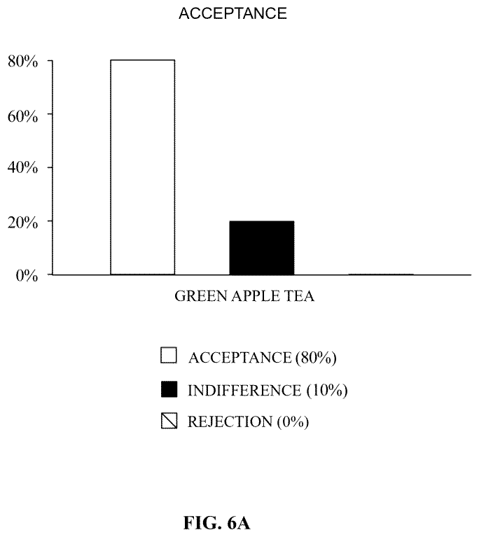

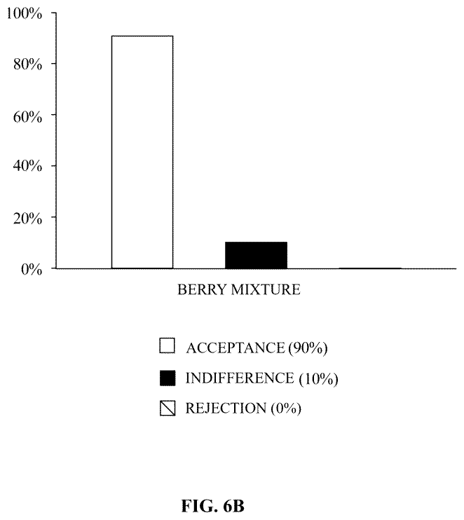

The sensory attribute description results for the formulations are shown in FIGS. 5A and 5B for the green apple tea and berry blend flavorings, respectively. The results obtained in the acceptance test are shown in FIGS. 6A and 6B for the formulation flavored with apple green tea and mixed berries, respectively.

Regarding sensory attributes, all received good scores; the lowest-scoring attribute was sweetness (score 4/5). However, in line with the concept, it is necessary to begin educating consumers about this sweetness level. An acceptance of 80 and 90% of the product is obtained for apple green tea and mixed berries, respectively.

### Results

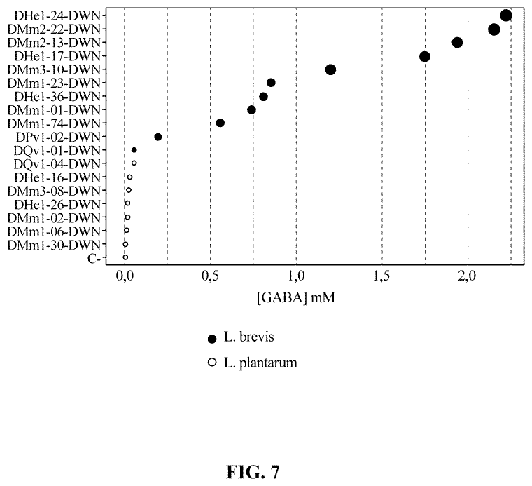

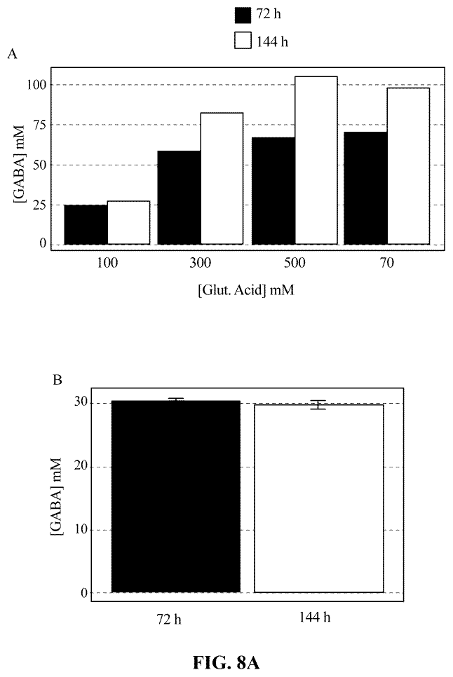

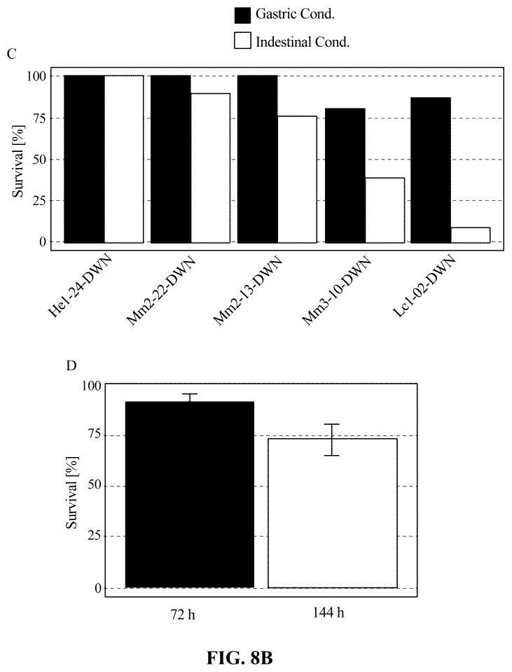

The probiotic strain, Lactobacillus brevis (with internal reference DHel_24_DWN), reached a GABA concentration of about 50 mg, after 144 hours, using different concentrations of glutamate (precursor of GABA biosynthesis) (FIG. 7). Additionally, GABA production was also tested under intestinal conditions, wherein extracellular production of up to 30 mM was achieved. The biosynthesis proved to be stable over time (FIG. 8).

### Example 7. Results of the Clinical Test and Effects of the Fermented Milk Drink on Mental Performance

A clinical test was conducted to evaluate the effects of the fermented milk drink of the present disclosure on mental performance in 100 healthy individuals, after 8 weeks of ingestion.

The inclusion criteria for the clinical test are men and women aged 18-60 years, individuals diagnosed with mild-moderate stress according to the Cohen Perceived Stress Scale (PSS-10); subjects with low adherence to the Mediterranean diet based on the PREDIMED questionnaire (score below 9 points); and BMI from 19 to 30 kg/m².

The effects of consuming the fermented dairy drink were evaluated based on criteria such as attention and vigilance, long-term episodic memory, and reasoning within executive function, all of which are described in detail below:

### Attention and Vigilance (or Sustained Attention)

This is defined as the ability to maintain attention and alertness over time, ignoring other stimuli that may divert focus from the target task, even as fatigue increases. Attention and vigilance were measured using the rapid visual information processing test and stroop test.

Rapid Visual Information Processing Test: Rapid visual information processing is a subtask of attention that enables individuals to attend and process the volume of visual stimuli to which they are exposed, with the goal of discarding information they do not need for the task at hand and selecting stimuli that can help them solve the task.

Test design: A series of numbers appear on the screen in rapid succession and the participant must respond when they see a sequence of three even or odd numbers by pressing the bar on the screen.

### Results

Percentage of accuracy for correct responses: Treatment with the functional product produced a significant increase (p<0.05) in the percentage of accuracy for correct responses at the end of the study compared to the beginning, that is, at the third visit.

The improvement in scores on these tasks indicates that people taking the functional product processed visual information more effectively, showing a significant improvement in their ability to maintain attention and correctly discriminate stimuli. These results suggest that ingesting the functional product could improve the performance of tasks such as driving, studying, or selecting information to which attention is paid in hyperstimulated contexts.

Stroop Test: This test assesses the ability to attend to more than one stimulus at a time, so that the individual decides which is the most important and focuses their attention on it, while inhibiting the responses that are triggered to respond to the other stimulus. This ability is called selective attention, which allows us to pay attention to stimuli relevant to the task we are performing and ignore information irrelevant to our goal.

Test design: The individual is given a series of words that name colors and each word being displayed in a color different from the color it denotes. The participant is instructed to indicate the color of the word, rather than the color it refers to.

Results: the number of correct responses corresponding to the Stroop test increased significantly (p<0.05) at the end of the study for those individuals who consumed the functional product.

This task assesses the ability to inhibit behaviors. Therefore, the increase in correct responses may indicate an improvement in self-regulation of behavior as an effect of the functional product. This self-regulation capacity is important for selecting relevant information from the environment, or controlling impulsiveness, mainly.

As a general conclusion from all these tasks assessing the participants' attentional capacity, a trend was observed toward improved reaction times and an enhanced ability to respond correctly, as well as to inhibit automatic behaviors that differ from those required by the task. These results suggest that consumption of the functional product may lead to an increase in attention, enabling the individual to respond more efficiently to environmental demands by improving their ability to concentrate and to ignore stimuli that are less relevant to the task at hand. The relationship between attention and memory is close; thus, improvements in attention and concentration may lead to enhanced memory performance.

### Long-Term Episodic Memory

Episodic memory refers to the set of memories that can be easily recalled concerning an individual's personal experiences, the context in which they occurred, and all associated details. This type of memory is one of the most vulnerable to age-related cognitive decline. Therefore, the intake of the functional product could partially contribute to protecting the individual against the effects of aging on memory.

### Delayed Word Recognition

After completing all the neurocognitive assessment tests, the participant is again given a series of words and must respond by indicating whether that word was on the list of words given in the word recognition test. The test seeks to assess other components of attention and memory, more related to the storage of information and the ability to recall what has been learned after a period of time (delayed recall).

Treatment with the functional product significantly increased the percentage of correct responses at the end of the study compared to the beginning.

There was a significant increase in the percentage of correct “Yes” responses at the end of the study. The intake of the functional product increased the percentage of accuracy of correct responses “No” with a significant increase (p<0.05) at the end of the study.

General reaction time: It significantly decreased at the end of the study (p<0.05).

Reaction time for correct responses: A decrease very close to statistical significance was obtained (P=0.084).

The group treated with the functional food significantly reduced the reaction time for the correct “Yes” responses (p<0.05) after 8 weeks of intake. A non-significant reduction in reaction time was observed for the “No” response.

### Delayed Picture Recognition

To perform this test, the participant is given images again after completing other tests from the neurocognitive battery (i.e., delayed recall of images was assessed after completing other tasks). The participant is required to respond by indicating whether the image was among those given during the picture recognition test.

The percentage of correct answers increased significantly (p<0.05) in the group that ingested the functional product for 8 weeks.

The study group experienced a significant increase in “Yes” responses at the end of the study. The percentage of accuracy for correct “No” responses increased statistically significantly (p<0.05) for the group, concluding that the effect on the improvement of this parameter is due to the intake of the functional product.

General reaction time: The time it took for individuals to react to the stimulus decreased non-significantly after 8 weeks.

Reaction time for correct responses decreased significantly (p<0.05). The reaction time for the “Yes” response was reduced, but not significantly. No changes were obtained in reaction time for the “No” response.

Regarding the results of the episodic memory test, there is evidence suggesting that episodic memory in the treatment group improved, although there is also evidence indicating that the improvements may be attributable to learning effects, such as repetition of the task and increased familiarity with it. However, since this type of memory is one of the most sensitive to age-related decline, the intake of the functional product could, in part, contribute to protecting the individual against the effects of aging on memory.

If these data are analyzed together with the data obtained in the attention tests, a relationship can be inferred between the improvement in attention in the group that consumed the functional product and the delayed retrieval of information, including both word-related and image-related information. Episodic memory relies heavily on attention: if attention is not paid to a stimulus (e.g., if something distracts us, such as performing other tasks from the neuropsychological battery), it is generally less likely that the memory of that stimulus can be retrieved later.

### Executive Function Reasoning

Executive function encompasses a set of cognitive skills that are very important for everyday life, as they allow an individual to plan goals and objectives, sequence tasks to achieve objectives, make decisions, or self-regulate behavior, for example, by inhibiting certain responses. Good executive function is essential for daily life as it plays a central role in coordinating different neuropsychological functions such as attention and memory.

### Peg and Ball Test

Test design: Two configurations appear on the screen, each with three colored balls on one of the three pegs. The setting that appears at the top of the screen is the goal that the participant must achieve in the fewest possible moves.

Measure taken: The average reflection time (time it takes to make a move) and completion time (when the target configuration is achieved) are obtained, and the errors are the total number of unnecessary moves to complete it.

Result obtained: The average reflection time spent by participants to solve the given problem was lower at the end of the study. Although there was no statistically significant variation over time, nor a significant time×treatment interaction, there is evidence suggesting that treatment with the functional product led to an improvement in executive functions, as reflected by the reduced time taken to respond to the given problem. These results can be interpreted in light of the improvements observed in the attention tests, given the conceptual and functional proximity between attention and executive functions. One might expect that an increase in the ability to sustain attention for a prolonged period of time (vigilance) would lead to an improvement in the ability to solve problems. The ability to maintain attention without being distracted by irrelevant stimuli in the environment facilitates effective problem solving.

The mean completion time decreased during the study, but not significantly. The number of errors decreased significantly during the study for the functional group (p<0.05).

There is evidence to suggest that the treatment has produced improvements in executive functions, specifically in problem-solving ability, as fewer errors were made when attempting to solve problems after taking the functional product. Based on the results obtained in the attention and memory tests, it is possible to relate the improvements in these variables (improved concentration, increased inhibition of automatic behaviors, and improved ability to focus attention on what is important) with this improvement in problem solving observed in the Peg-and-Ball test.

These results suggest that the intake of the functional product may be beneficial for individuals, as many everyday situations require the ability to select relevant information from a highly stimulating environment, to disregard distracting information, and to concentrate on aspects that are essential for achieving a given goal.

1. A fermented dairy drink formulation comprising: a dairy matrix, a starter strain, a GABA-producing probiotic strain, and a nutrient mixture,
wherein the nutrient mixture comprises choline, vitamin B5, and vitamin B12,
wherein the starter strain is Streptococcus thermophilus and wherein the GABA-producing probiotic strain is Lactobacillus brevis.

2. The formulation of claim 1 comprising 70 to 99% (w/w) dairy matrix, 0.0005 to 0.005% (w/w) starter strain, 0.002 to 0.01% (w/w) GABA-producing probiotic strain, and 0.5 to 0.9% (w/w) nutrient mixture.

3. The formulation of claim 1 comprising
a) the starter strain Streptococcus thermophilus at a concentration of 1×10¹⁰ CFU/g to 1×10¹² CFU/g or an activity of 0.5 to 1.5 U/100 L; and
b) the GABA-producing probiotic strain Lactobacillus brevis at a concentration of 1×10¹⁰ CFU/g to 1×10¹² CFU/g.

4. The formulation of claim 1, wherein the nutrient mixture comprises choline from 10 to 15%, vitamin B5 from 0.2 to 0.5%, and vitamin B12 from 0 to 0.1%.

5. The formulation of claim 1 having a probiotic count from 1.0×10⁶ to 1.0×10⁷ CFU/mL.

6. The formulation of claim 1 comprising 5 to 10% sweeteners, 1.5 to 5% protein, 1 to 3% fat, and 15 to 20% total solids.

7. A process for obtaining a fermented dairy drink comprising:
a) inoculating a food mixture with a starter strain and a probiotic strain;
b) acidifying the inoculated mixture from step (a) to a pH below 4.8;
c) cooling the acidified mixture obtained in step (b); and
d) adding a mixture of nutrients to the mixture obtained in step (c) until a fermented dairy drink is obtained;
wherein the food mixture comprises milk, whey, and stabilizers;
wherein the starter strain is Streptococcus thermophilus, and the GABA-producing probiotic strain is Lactobacillus brevis; and
wherein the nutrient mixture comprises: choline, vitamin B5, and vitamin B12.

8. The process of claim 7, wherein the food mixture of step (a) further comprises sweeteners.

9. The process of claim 7, wherein step (b) comprises acidifying the inoculated mixture for 5 to 10 hours at a temperature from 35 to 50° C. and up to a pH cut-off from 4.5 to 4.7.

10. The process of claim 7, wherein step (d) the diluted nutrient mixture is obtained as follows:
i) dissolving the nutrient mixture in water at a temperature from 28 to 32° C.;
ii) homogenizing the mixture from step (i) until a total dilution is achieved;
iii) cooling the mixture from step (ii) to a temperature from 15 to 20° C., and obtaining a solution of a nutrient mixture;
where the nutrient mixture is from 20 to 30% of the solution.
